(19) United States
(12) Patent Application Publication
(10) Pub. No.: US 2013/0144943 A1
(43) Pub. Date: Jun. 6, 2013

(54) METHOD AND SYSTEM FOR INTERFACING DISPARATE NETWORKED SERVICES

(71) Applicant: Michael Scissons, Toronto (CA)

(72) Inventor: Michael Scissons, Toronto (CA)

(21) Appl. No.: 13/128,332

(22) PCT Filed: Jun. 7, 2010
(86) PCT No.: PCT/CA10/00858

§ 371 Date: Feb. 13, 2013

(51) Int. Cl. H04L 29/06

(52) U.S. Cl. CPC H04L 65/403
USPC 709/204

(57) ABSTRACT

A system and method for connecting a plurality of disparate social networks or social media systems and providing for transfer of user generated content. The system comprises a broadcaster operatively coupled to a plurality of service managers. Each of the service managers is associated with or operatively coupled to a social media system or social network. The service managers are configured to receive and transmit data from the associated social media system or social network. The broadcaster is configured to receive data from any one of the service managers and re-route or replicate the data to any one of the other service managers. According to another aspect, the service managers are configured to generate a proxy user for data replicated on one or more social media systems where the originating user for the data does not have credentials.

### FIELD OF THE INVENTION

The present invention relates to social media services and networks, and more particularly, to a method and system for coupling disparate networked services and providing data transfer between the services or networks.

### BACKGROUND OF THE INVENTION

Social networking and Internet based social networks or social media systems are becoming more and more popular. Membership continues to grow for the various services. With the growth and popularity of social networks or social media systems, users typically join or subscribe to more than one service. Despite the widespread popularity of social networking, the networks and media systems tend to function as stand-alone entities. This means that a user or subscriber to a social network can only stay connected or interact with other members of that social network or social media system. Furthermore, the disparate nature of the social media systems makes it difficult to share user content between the systems. As such the ability to stay connected and/or share content becomes limited by the boundaries of the particular social network or service.

In view of the growth of social networks and the popularity of social networking, there remains a need for improvement in the art of allowing users of disparate social network or media systems to “stay connected” and/or share content.

### BRIEF SUMMARY OF THE INVENTION

The present invention is directed to embodiments of a method and system for connecting social networks or social media systems together and providing the capability to replicate or transparently share user generated content.

According to an embodiment, the present invention provides a system for connecting a plurality of social media systems, the system comprises: a broadcaster; a service manager for each of the plurality of social media systems, the service manager being operatively coupled to a respective one of the plurality of social media systems, and each of the service managers including a module configured to receive data and a module configured to transmit data to the associated social media system; the broadcaster being operatively coupled to each of the service managers and including a module configured to receive data from each of the service managers and a storage module configured to store said received data; and the broadcaster including a module configured to determine one or more of the social media systems for replicating the received data, and said broadcaster including a module configured to transfer the received data to the respective service manager associated with each of the one or more social media systems, and the service managers including a module configured to replicate the received data to the associated social media system.

According to another embodiment, the present invention provides a method connecting a plurality of different social media systems and providing transparent transfer of user content between one or more of the plurality of different social media systems, the method comprising the steps of determining the creation of a new data object or the modification of a data object at one or more of the social media systems; inputting the new data object or the modified data object and storing the data object; determining one or more destination social media systems for replicating the data object; converting the data object in a format compatible with the one or more destination social media systems; and replicating the format compatible data object to the one or more destination social media systems.

Other aspects and features according to the present application will become apparent to those ordinarily skilled in the art upon review of the following description of embodiments of the invention in conjunction with the accompanying figures.

### BRIEF DESCRIPTION OF THE DRAWINGS

Reference will now be made to the accompanying drawings which show, by way of example, embodiments according to the present invention, and in which:

FIG. 1 shows in block diagram form a system for connecting social media systems or services together according to an embodiment of the present invention;

FIG. 2 is a flowchart depicting the processing steps embodied in an import mechanism for the system of FIG. 1 and according to an aspect of the present invention;

FIG. 3 is a flowchart depicting the processing steps embodied in an export mechanism for the system of FIG. 1;

FIG. 4 is a flowchart showing the steps embodied in a normalization process or procedure according to an embodiment of the invention;

FIG. 5 is a flowchart showing the steps embodied in a process for mapping and routing data between social networks or social media systems according to an embodiment of the invention;

FIG. 6 is a diagrammatic representation of an exemplary implementation for social network and social media utilizing the system according to the present invention;

FIG. 7 shows an exemplary “config” file in pseudo-code format according to an aspect of the invention; and

FIG. 8 shows an exemplary “config” field map in pseudo-code format according to an aspect of the invention

Like reference numerals indicate like or corresponding elements in the drawings.

### DETAILED DESCRIPTION OF THE EMBODIMENTS

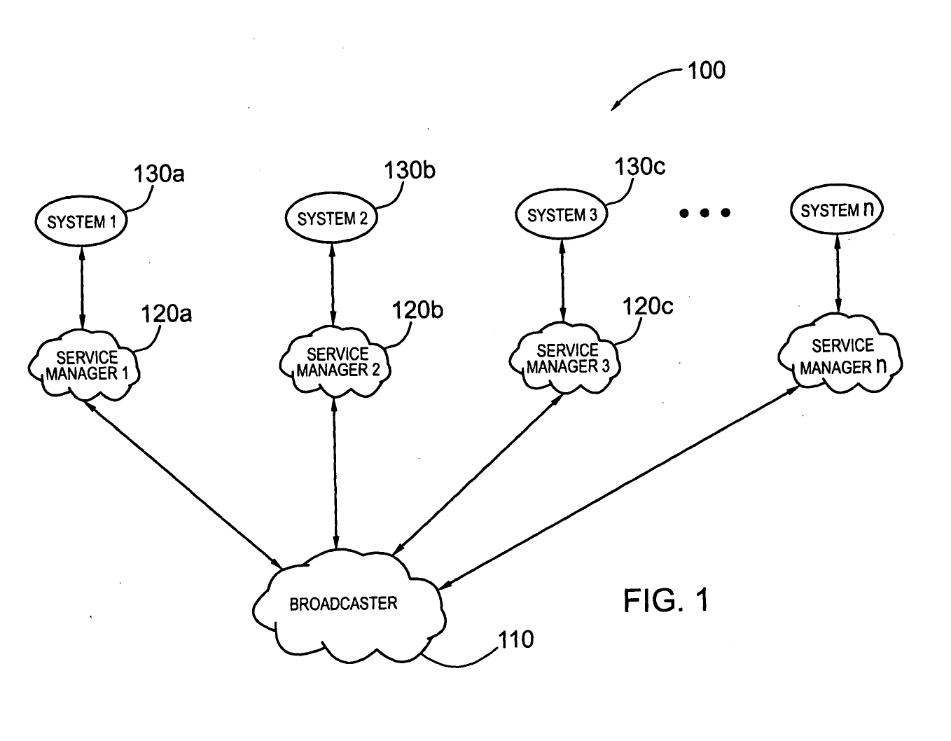

Reference is first made to FIG. 1, which shows in diagrammatic form a system for connecting a plurality of disparate social networks or social media systems according to an embodiment of the present invention. The system is indicated generally by reference 100 and comprises a broadcaster processor or module 110 and a plurality of service manager processor or modules 120, indicated individually by references 120a, 120b, 120c in FIG. 1. As will be described in more detail below, each of the service managers 120 interfaces the broadcaster 110 with an associated social media system indicated generally by reference 130 in FIG. 1. For the exemplary implementation depicted in FIG. 1, the social media systems 130 comprise three disparate social media systems indicated individually by references 130a, 130b and 130c, respectively, but can be configured or extended for any number of social media systems, i.e. to social media system 130n. The social media systems 130 can comprise various web services, such as, Jive™, Facebook™, YouTubeυ, Twitter™, and the like. As will be described in more detail below, the broadcaster 110 and the service manager 120 are configured to provide functionality to link the social media systems 130 together and allow users or subscribers to share user generated content. According to an embodiment, the system 100 is configured to run and monitor the multiple social media systems 130 and detect new or modified content that can be replicated, based on specified export criteria, such as type of data or object, and then broadcast or replicated to the other social media systems 130.

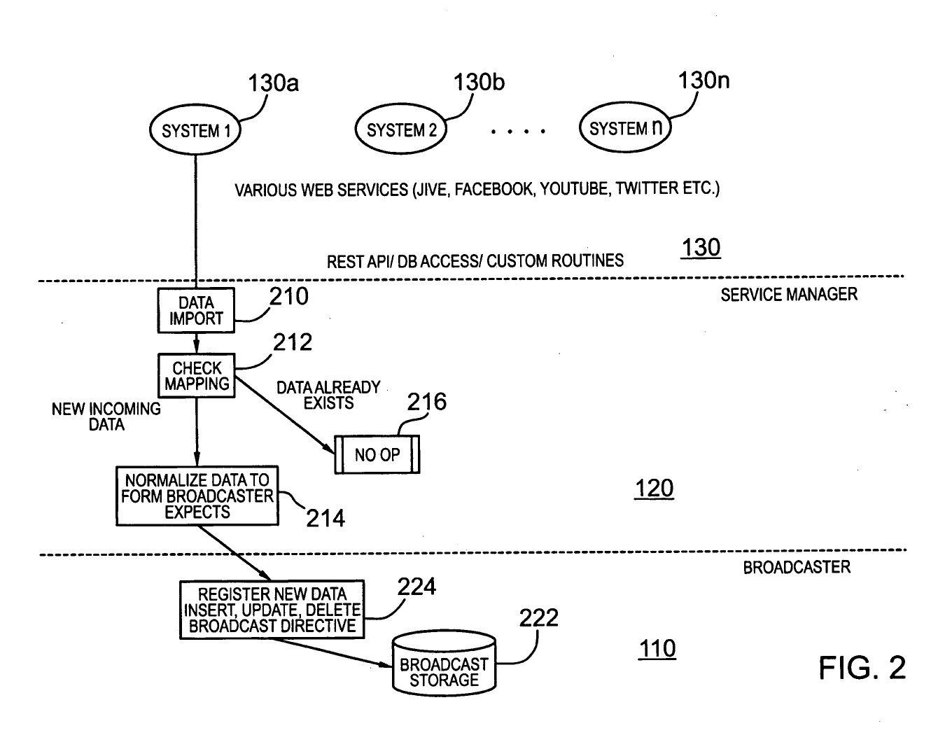

Reference is next made to FIG. 2, which shows the service manager 120 and the broadcaster 110 in more detail and configured to process incoming data according to an embodiment of the invention. As shown, the service manager 120 comprises a data import module or process 210, a mapping check module or process 212 and a data normalization module or process 214. The data import module 212 interfaces with the associated social media service 130 (for example, the social media service denoted by reference 130a in FIG. 2). The data import module 212 is configured to monitor the social media service 130 and look for, or determine, new or changed data at the social media service 130 that can be replicated to the other social media services 130b and/or 130c, as will be described in more detail below. The mapping check process 212 is configured to determine if the data is to be replicated, as will be described in more detail below. The data normalization module 214 is configured to convert the node data into a generic representation or a centrally readable format, as will be described in more detail below. According to an embodiment, the data import module, the mapping check module 212 and the data normalization module 214 comprise software services or processes or code components implemented with executable code that runs on one or more computers, processors or other types of processing platforms to perform the functionality as described herein. The particular hardware and software implementation and coding details will be within the understanding of one skilled in the art.

As shown in FIG. 2, the data import process 210 interfaces with the associated social media service 130a, and is configured to determine if there is data, i.e. node data, available from the service 130a for import. The determination can be made by the data import process 210 issuing a data update request to the service, or the data import process 210 being configured to “listen” for requests from the service 130a, or with service 130a being configured to download data changes to the data import process 210 asynchronously in real time, or according to a schedule. According to an embodiment, the social media service 130 is configured with log table triggers, for example, built into the data storage engines of the service 130. The log table triggers are updated in response to the addition, modification or deletion of data content at the service 130. The data import process 210 is configured to access the log table triggers and detect node data that has been changed. According to another embodiment, the social media service 130 is configured to expose Web API calls which return a delta of activity on the service 130, between specified periods of time or on a scheduled basis. The data import process 210 responds to the delta activity to detect new or modified node data. According to another embodiment, the data import process 210 is configured to compare the node data at the service 130 to a previous version or copy of the node data, and differences between the two sets of data represent the changes in the node data. Upon determining that new or modified data, i.e. node data, is available from the service 130, the data import process 210 imports or inputs the node data to the service manager 120 for further processing. According to an embodiment, the node data or data objects comprise Web-based data including RSS, HTML, JSON and other HTTP based data streams. According to another aspect, the data objects comprise program generated data objects, such as, programming code API's or database entries or objects.

The imported node data is processed by the mapping check process 212 as shown in FIG. 2. According to an embodiment, the mapping check process 212 is configured to identify or map node data that is to be replicated, or is suitable for, replication to the other social media services 130. The mapping or routing of the node data can be based, for example, on export criteria such as the type of data object. For example, data coming in from Twitter™ service which comprises 140 character text strings, may not be suitable to be replicated to other nodes, such as a YouTube™ service or node, which is better served by data containing video. According to another aspect, the mapping check process 212 is configured to determine if the node data already exists, and according to this aspect no further processing is performed on the duplicate node data as indicated by processing module 216. If the node data comprises new data, then the node data is processed by the data normalization process or module 214.

The data normalization process 214 is configured to transform or convert the node data (i.e. the new incoming data) into a generic or transportable data object format. According to this aspect, the transportable data object format is distributed to other service managers 120 in the system 100 and then subsequently replicated (e.g. for sharing or synchronization) to the other social media services 130 as will be described in more detail below. According to an embodiment, the node data is normalized according to a common set of data fields, or a least common denominator set of data fields, that are uniform. According to one aspect, the data normalization process 214 utilizes a uniform set of data fields that is relevant or related to the different end points (i.e. the nodes or services). This establishes a common baseline of data that can be transposed to the other social media services 130. According to one aspect, node data that does have the same (or similar) set of data fields is excluded from replication or distribution to the other social media services 130. As shown in FIG. 2, the normalized node data is then transferred to the broadcaster module 110.

Referring again to FIG. 2, the broadcaster module 110 includes a storage media or database 222 configured for storing the normalized node data received from the service manager 120. The storage media 222 comprises a data repository and/or data structures configured in non-volatile memory or storage device(s) for storing the normalized node data for retrieval and distribution to the other social media services 130. According to an embodiment, the broadcaster module 110 includes a data registration module or process indicated by reference 224. The data registration process 224 is configured to register the node data, i.e. create a record that the object (node data) was imported into the system 100. In this way, a normalized copy of the most recent node data or object is stored in the database 212. According to another aspect, the record created by the data registration process 224 can further specify an associated operation with the object, for example, whether the object is to be inserted, updated or deleted at the destination nodes. According to another aspect, a broadcast directive is generated and comprises the destination service or services 130 for distributing the object.

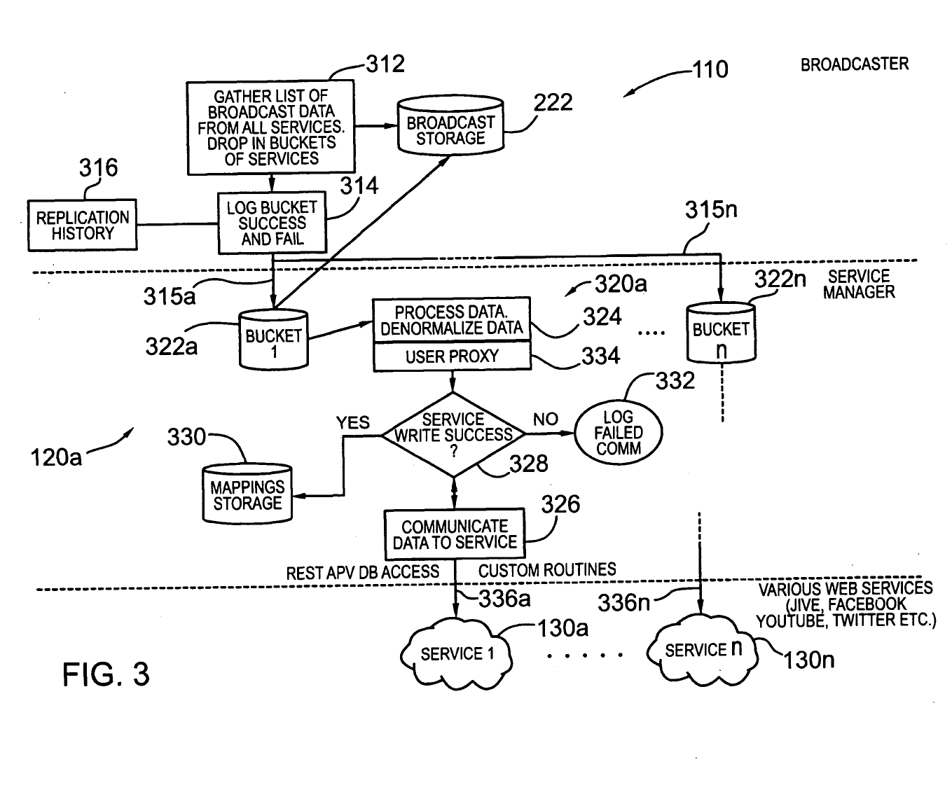

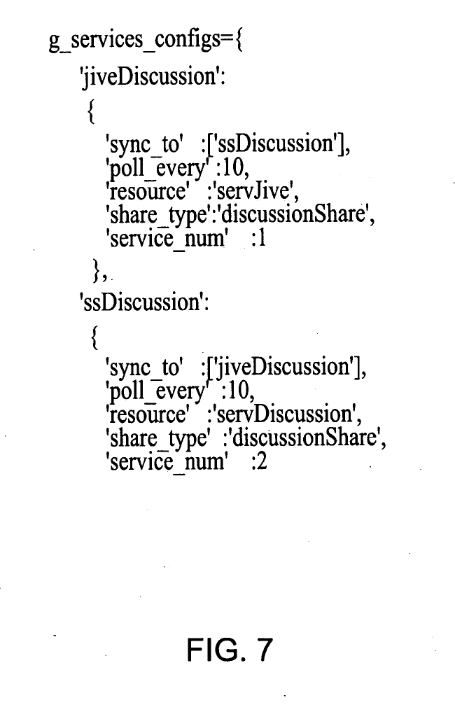

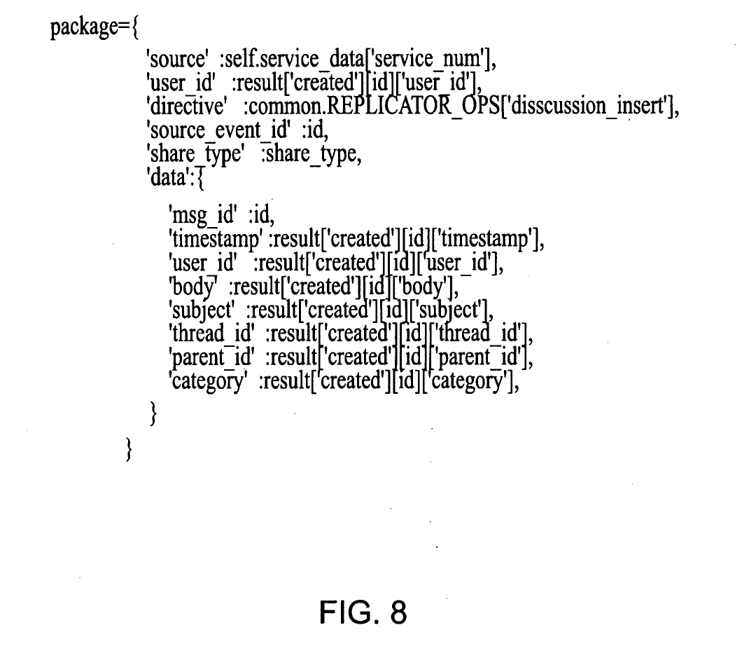

Reference is next made to FIG. 3 which shows a process for distributing or replicating outgoing data or objects, according to an embodiment of the present invention, to one or more of the social media services 130, i.e. the replication targets or destination nodes. As described above, the node data or objects to be replicated or distributed a stored in the broadcast storage module 212. As also described above and according to another aspect, the data is stored in normalized form. According to an embodiment, the broadcast module 110 includes a replication process or module 312 that is configured to generate or compile a list of data objects from the broadcast storage 212 that are to be replicated or distributed to the social media services 130. According to an aspect, the data objects are further identified or categorized according to the intended replication target(s). According to another aspect, the replication process 312 is configured with a mapping or routing mechanism for mapping and routing the data object(s) to the appropriate service(s) 130. According to this aspect the data object(s) can be replicated to all, or to one or more of, the services 130. According to an embodiment, the mapping and routing mechanism 312 is configured with “config” files. The config files are set up to define which direction (e.g. upstream, downstream or both) the data objects are replicated between the various services 130. The config files are also set up to define which nodes (i.e. services) share data and with which nodes the information is shared. An exemplary “config” file appears in pseudo-code form in FIG. 7. The mapping and routing mechanism 312 is configured to read the config files and route the data objects according to definitions in the config files. According to another aspect, the config files are also used to verify that the data object is complete, and to check for duplicate or overlapping replications, e.g. reposting a data object to the node that originated the data object. An exemplary config field map is shown in FIG. 8 in pseudo-code form.

According to an embodiment, each of the service managers 120 includes a bucket which is configured as a physical or virtual repository or storage space for the data objects to be replicated for the service 130 associated with the service manager 120. For the exemplary implementation depicted in FIG. 3, the service manager 120a includes a bucket denoted by reference 322a, and the nth-service manager 120n includes a bucket denoted by reference 322n. As shown the bucket 322a is operatively coupled to the broadcaster 110 as indicated by reference 315a, and configured to receive the data objects intended for replication or distribution to the service 130a.

Referring again to FIG. 3, the broadcaster 110 is configured with a data object transfer process or module indicated by reference 314. The data object transport process 314 is configured to transfer the data object(s) from the broadcast storage device 222 that are intended for the service 130a associated with the service manager 120a (i.e. the data objects in the list from the replication process 312). The data object(s) are retrieved from the broadcast storage device 222 and transferred (e.g. copied or written) to the bucket 322a for the service manager 130a. According to an embodiment, the data object process 314 includes a log process or module configured to log successful (and/or unsuccessful) data object transfers from the broadcast storage device 222. According to a further embodiment, the broadcaster module 110 includes a replication history process or module indicated by reference process 316. The replication history process 316 is configured to generate a replication history and associated metrics for each service media service or node 130 and/or replication event.

As shown in FIG. 3, the service manager 120 is configured with a processor or mechanism indicated generally by reference 320 (and individually by reference 320a) to replicate (e.g. synchronize or distribute) the data objects received from the broadcaster 110 and stored in the bucket 322. The processor 320a comprises a process or module for de-normalizing the data 324 and a data communicate process or module 326. According to an embodiment, the de-normalization process 324 is configured to de-normalize or convert the data object(s) into the native format (i.e. specific data format) compatible with the social media service 130a. The de-normalized data object is then synchronized or replicated to the associated service 130a by the data communicate process 326. As depicted again in FIG. 3, the service manager 120a is operatively coupled to the associated social media service 130a by a communication link 336a, for example, a high speed wireless or cable transmission link or channel or other type of digital or analog communication channel. According to an embodiment, the replication process 320 includes a service write/verify process or module indicated by reference 328, which is configured to check or verify the transfer or replication of the de-normalized data object(s) to the service 130a. According to one aspect, the service write/verify process 328 is configured to generate a mapping record for the data object transfer. The mapping record is stored in a mapping database storage device or appliance indicated by reference 330. If the transfer or synchronization of the de-normalized data object is not successful, then a failed communication log is generated as indicated by reference 332. The failed log can be included in the log generated for the data object record.

According to another aspect, the service write process 328 is configured to generate a data log comprising metrics for each data object that is processed or replicated in the system 100. According to a further aspect, the processing of the data object can include one or more of the following operations: updating, deleting, insertion (into the associated service 130). According to an embodiment, the service manager 130 includes a data structure, e.g. a “mysql” table, that is contained in the mapping database device 330. The mysql table is configured with a complete log of the data object operations and/or metrics are recorded and stored.

According to an embodiment, the replication processor 320 includes a user proxy process or module indicated by reference 334 as shown in FIG. 3. The user proxy process 334 is configured to create a proxy user associated with certain types of data objects that are to be replicated or transferred to other destination services 130. According to an embodiment, the created proxy user comprises a mirror of the user who generated the data object (e.g. content) on the originating service 130. For example, a discussion on one of the services 130 will generate data objects comprising the discussion. To replicate the discussion data object(s) on other services 130, the user proxy process 334 is configured to generate a proxy user associated with the discussion data object(s) that are replicated to one or more of the other services or systems 130. According to one aspect, the proxy user is not associated with a login or user credentials on the destination service(s) 130, rather the proxy user is associated with the replicated discussion data object(s) and thereby provides a context for the discussion content on the destination service(s). The proxy user mechanism can be used with other types of user generated content or data objects that require an associated author or user, who may not necessarily exist on one or more of the replication targets, i.e. the destination services 130. For example, if a user posts a video on Youtube™, and it is desired to replicate the video to a Jive™ SBS server, then an approach involves creating a new Document on the Jive server with a video attachment. In the context of a social networking system, content cannot exist without a creator. In the event that the creator of the YouTube™ content is not known on the Jive™ SBS server, the system 100 is configured to create a new user profile object (e.g. a proxy user) which would serve as a creator. According to another aspect, the proxy user mechanism can be configured to generate anonymous or shielded users.

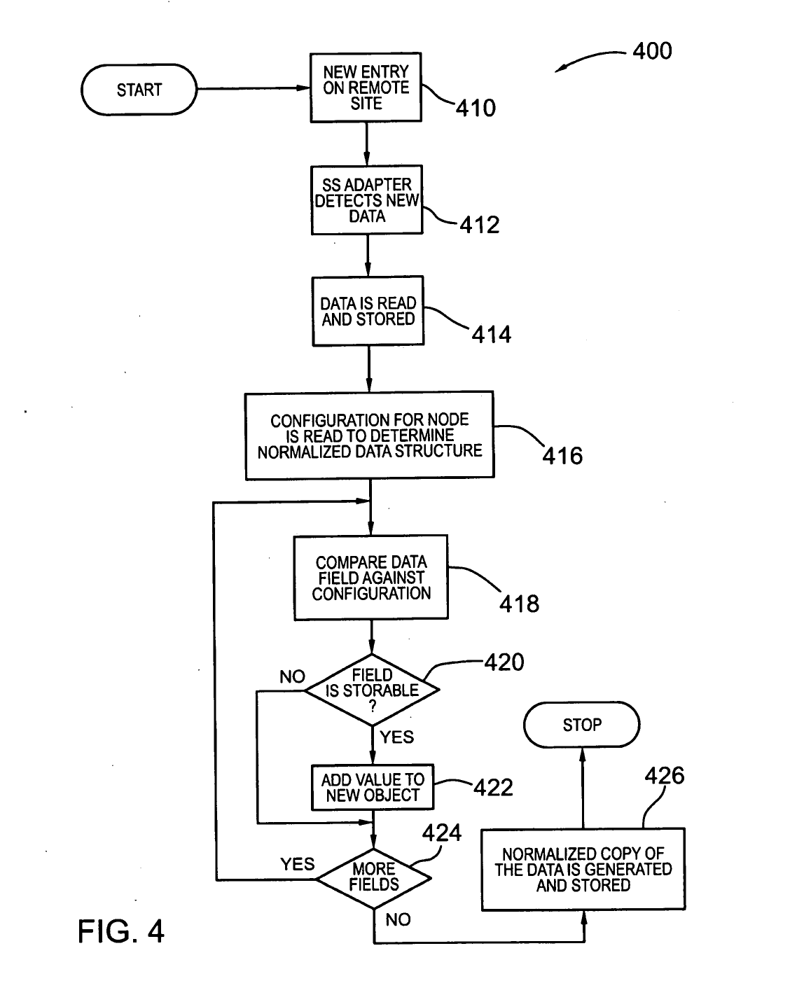

Reference is next made to FIG. 4, which shows in flowchart form a data object input and normalization process according to an embodiment of the present invention and indicated generally by reference 400. According to an embodiment, the processing steps embodied in the normalization process 400 are embodied in software or computer code executed by one or more computers, processors, or other processing platforms or devices, configured in the system 100 of FIG. 1. The first step in the normalization process 400 comprises determining or detecting a new data object 410 as indicated by block 412. As described above, the new data object can comprise new content created by a user, existing content that has been modified by a user, or the deletion of an existing data object (e.g. content) by a user. The process for detecting a new data object can comprise looking at log table triggers, using Web API calls that return a delta for activity on the node, and/or comparing the data content of the node to a previous copy of the data content of that node. Once the existence of new data is determined, the data object is read and stored in memory as indicated by block 414. The next step in block 416 comprises determining (e.g. retrieving from memory) a data configuration for the destination node and using the data configuration to determine the normalized data structure for the data object. As discussed above, a data object is normalized according to one or more uniform data fields comprising the normalized data structure. Next in block 418, a data field from the data object is compared against the normalized data structure. If the data field is valid, for instance storable, as determined in decision block 420, than the data field is stored as part of a new data object in block 422. If, on the other hand, the data field is not valid, then a check is made in decision block 424 to determine if the imported data object includes any more data fields. If yes, then the comparison process described above for steps 418 to 422 is repeated. If there are no more fields to compare in the data object, then a normalized copy of data object is generated based on the stored data fields and the normalized data object is stored, for example, in the broadcast storage database 222 described above with reference to FIG. 2.

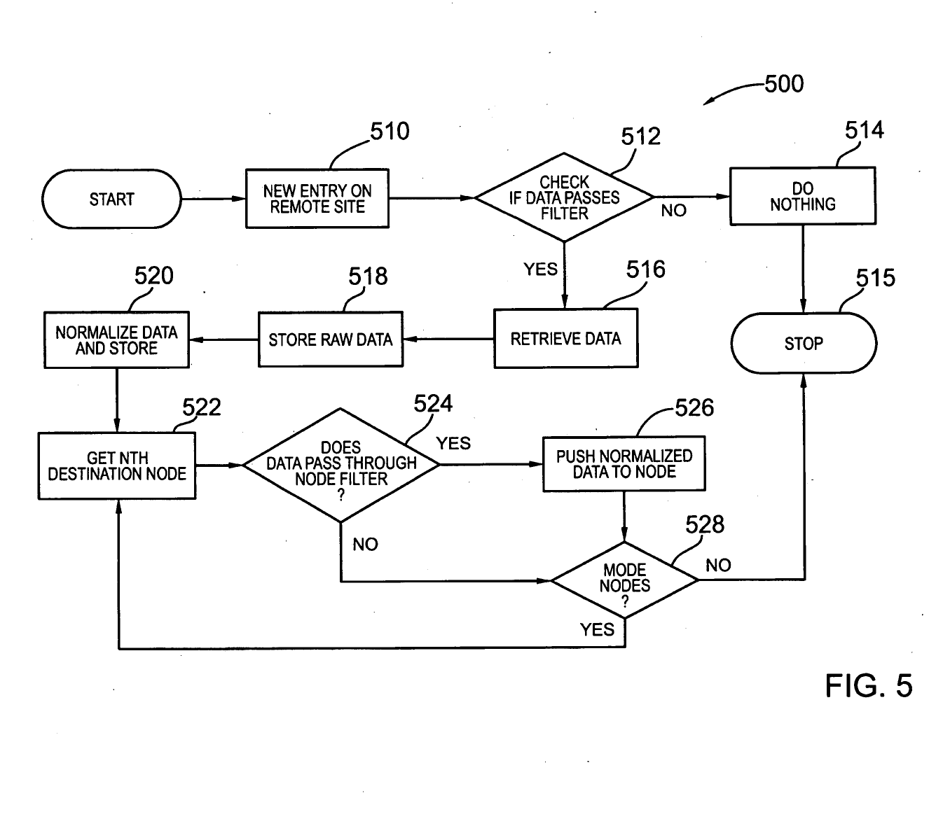

Reference is next made to FIG. 5, which shows in flowchart form a data object filtering and normalization process according to an embodiment of the invention and indicated generally by reference 500. As will be described in more detail, the process depicted in FIG. 5 comprises a normalization process similar to that described above with the addition of an input filtering operation and/or an output filtering operation. According to an embodiment, the processing steps embodied in the filtering and normalization process 500 are embodied in software or computer code executed by one or more computers, processors, or other processing platforms or devices, configured in the system 100 of FIG. 1. The first step comprises determining a new entry, i.e. data object, on one of the nodes or services 130, as indicated by block 510. Next in decision block 512, a filtering operation is applied. According to this aspect, the filtering operation comprises screening the data object and determining if further processing (i.e. replication) of the data object should be performed. The screening can be based on any number of criteria, such as, for example, type of data object, size of the object, content of the data object, user associated with the data object, originating node or service for the data object, state or operating mode of the destination node(s) (i.e. capacity, service or maintenance schedule). If the data object passes the filtering step 512, then the data object is retrieved or inputted from the originating node or service 130 (FIG. 1) by the associated service manager 120 (FIG. 1) and stored as raw (i.e. un-normalized) data in memory as indicated by block 518. The next step as indicated by block 520 comprises normalizing and storing the data object for example as described above. The process 500 then determines the destination node(s) for the normalized data object in block 522. As described above, the destination node(s) can be determined using the mapping and routing mechanism comprising “config” files, as described above. Once the destination node(s) are determined, the process 500 can include another filter operation as indicated by decision block 524. According to an embodiment, decision block 524 is configured to determine if the intended destination node(s) are configured or able to accept the data object. If yes, then the normalized data object is pushed or queued for the intended destination node as indicated in block 526. As described above, the normalized data object is converted into a native-format compatible with the destination node prior to being synchronized or replicated at that node. A check is then made in decision block 528 to determine if there are any more intended destination nodes for the data object. If yes, then the processing according to steps 522 to 526 are repeated, as described above. If the intended destination node is not able or not configured to accept the data object (as determined in step 524), then a check is also made in decision block 528 to determine if there are any other intended destination nodes. If yes, the processing according to steps 522 to 526 are repeated. If no, then the process 500 terminates as indicated by reference 515. According to another embodiment, the process 500 can be configured the input filter step being bypassed (i.e. block 512) or configured with a relaxed or minimal input filter step (i.e. in block 512), and the filtering is predominately or exclusively based on the destination node (i.e. the node filter in block 524).

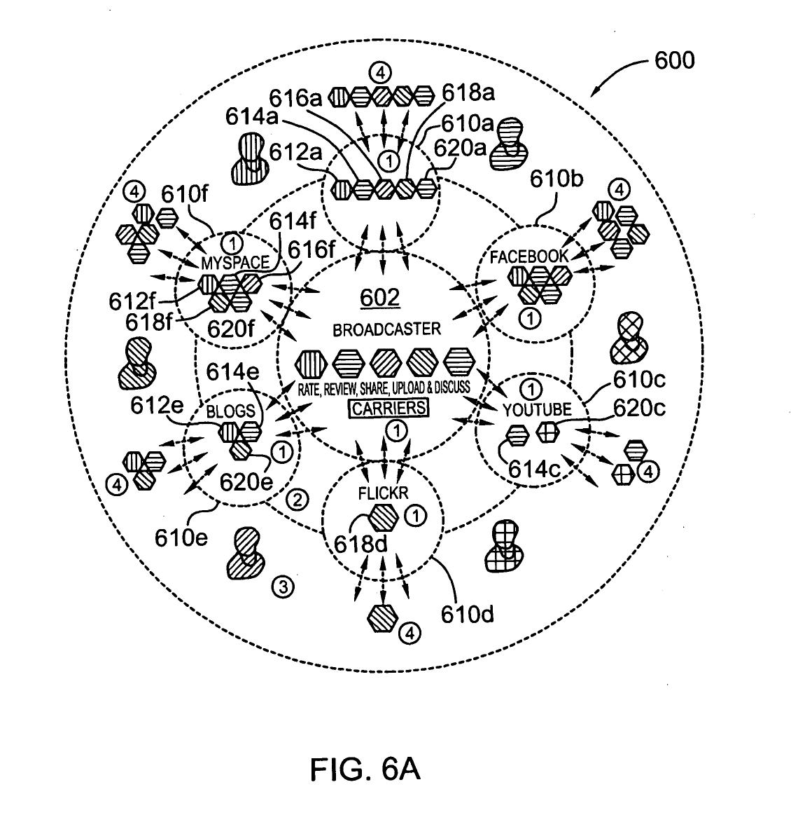

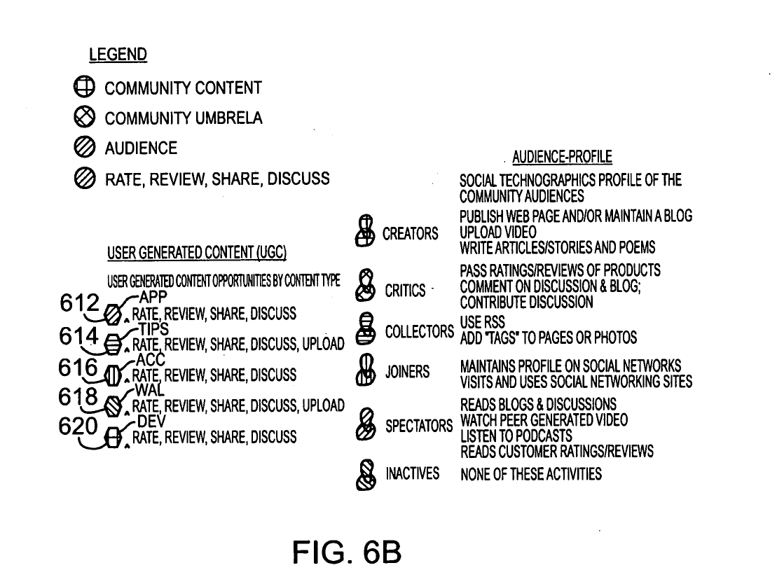

Reference is next made to FIG. 6, which shows in diagrammatic form an exemplary implementation for a system according to an embodiment of the present invention. The exemplary system is indicated generally by reference 600 and comprises a broadcaster 602 and a plurality of disparate social media services or nodes indicated generally by reference 610. The services or nodes 610 comprise a BlackBerry™ mobile device service 610a, a Facebook™ social network service, a YouTube™ service, a Flickr™ service, a Blogs™ service and a MySpace™ service. The services or nodes 610 are operatively coupled together through the broadcaster 602 and service managers (not shown) and configured to share user generated content in a manner as described above with reference to FIGS. 1 to 3. For the exemplary system 600 depicted in FIG. 6, the user generated content comprises application content (APP) indicated generally by reference 612, “tips and tricks” content (TIPS) indicated generally by reference 614, accessories (ACC) content indicated generally by reference 616, wallpaper (WAL) content indicated generally by reference 618 and devices (DEV) content indicated generally by reference 620. The user generated content is distributed or replicated from the originating service or node to one or more of the destination services or nodes in a manner as also described above. According to this exemplary implementation, the user generated content can be rated, reviewed, shared, discussed and/or updated. The user generated content is then replicated or synchronized with one or more of the destination nodes in a manner as described above, for example, with or without filtering.

While embodiments according to the present invention are described in the context of social media services, it will be appreciated that the embodiments have wider application to other types of networked services or configurations.

The present invention may be embodied in other specific forms without departing from the spirit or essential characteristics thereof. Certain adaptations and modifications of the invention will be obvious to those skilled in the art. Therefore, the presently discussed embodiments are considered to be illustrative and not restrictive, the scope of the invention being indicated by the appended claims rather than the foregoing description, and all changes which come within the meaning and range of equivalency of the claims are therefore intended to be embraced therein.

What is claimed is:

1. A system for connecting a plurality of social media systems, said system comprising:
a broadcaster;
a service manager for each of the plurality of social media systems, said service manager being operatively coupled to a respective one of the plurality of social media systems, and each of said service managers including a module configured to receive data and a module configured to transmit data to said associated social media system;
said broadcaster being operatively coupled to each of said service managers and including a module configured to receive data from each of said service managers and a storage module configured to store said received data; and
said broadcaster including a module configured to determine one or more of said social media systems for replicating said received data, and said broadcaster including a module configured to transfer said received data to the respective service manager associated with each of said one or more social media system, and said service managers including a module configured to replicate the received data to said associated social media system.

2. The system as claimed in claim 1, wherein each of said service managers includes a module configured to normalize said data received from said associated social media system, and said service managers being configured to transfer the normalized data to said broadcaster.

3. The system as claimed in claim 2, wherein each of said service managers includes a module configured to convert said normalized data received from said broadcaster into a format compatible with the intended social media system for replication.

4. The system as claimed in claim 1, wherein at least some of said service manager include a module configured to generate a proxy user, said proxy user being associated with data replicated to one or more destination social media systems.

5. The system as claimed in claim 4, wherein said replicated data comprises a user generated discussion at an originating social media system, and said proxy user corresponds to said user at said one or more destination social media systems without login credentials.

6. The system as claimed in claim 1, wherein said module configured to determine one or more social media systems for replication comprises a mapping and routing module responsive to configuration files generated in association with the respective social media systems and/or data objects associated with the social media systems.

7. The system as claimed in claim 6, wherein one or more of said service managers including a module configured to record metrics associated with one or more of the data objects.

8. The system as claimed in claim 1, wherein said service managers include a module configured to determine creation of a new data object or a modification to an existing data object and the associated social media system, and said module configured to receive data is responsive to input said new data object or said modified data object.

9. The system as claimed in claim 8, wherein said module is configured to access one or more log tables at the associated social media system and determine the creation of new data object or the modification of a data object based on said log tables.

10. A method connecting a plurality of different social media systems and providing transparent transfer of user content between one or more of said plurality of different social media systems, said method comprising the steps of:
determining the creation of a new data object or the modification of a data object at one or more of the social media systems;
inputting said new data object or said modified data object and storing said data object;
determining one or more destination social media systems for replicating said data object;
converting said data object in a format compatible with said one or more destination social media systems; and
replicating said format compatible data object to said one or more destination social media systems.

11. The method as claimed in claim 10, further including the step of normalizing the inputted data object into a generic data object format for storing in a storage repository.

12. The method as claimed in claim 11, further including the step of generating a proxy user for certain types of data objects, wherein said proxy user comprises a user without credentials on said one or more destination social media systems.

13. The method as claimed in claim 12, wherein a proxy user is generated for data objects comprising user generated discussion content.

14. The method as claimed in claim 13, wherein the social media systems comprise one or more of the Facebook™ service, the YouTube™ service, the Flickr™ service, and the MySpace™ service.

15. The method as claimed in claim 14, wherein said data objects comprise one or more of the following application content, tips content, accessories content, wallpaper content and devices content.

16. The method as claimed in claim 10, wherein said step of determining one or more destination social media systems further includes a filtering operation for determining whether any one of the destination social media systems is blocked from receiving the replicated data object.

17. The method as claimed in claim 10, wherein said step of determining one or more destination social media system further includes a filtering operation for determining whether the data object is blocked from being replicated to any one of the destination social media systems.

18. The method as claimed in claim 10, wherein said step of determining one or more destination social media systems for replicating said data object comprises processing one or more configuration files.

19. A computer program product comprising a computer readable storage media and executable instructions on said computer readable storage media configured for executing a method according to any one of claims 10 to 18.
